(19) United States
(12) Patent Application Publication
(10) Pub. No.: US 2008/0082305 A1
(43) Pub. Date: Apr. 3, 2008

(54) Fast method for predicting structure of membrane proteins

(75) Inventors: Chi-Ming Chen, Taipei (TW); Cheng-Chun Chen, Taipei (TW)

Correspondence Address: John G. Chupa;Law Offices of John Chupa & Associates, P.C., Suite 50, 28535 Orchard Lake Road, Farmington Hills, MI, 48334, US

(73) Assignee: NATIONAL TAIWAN NORMAL UNIVERSITY

(21) Appl. No.: 11/541,843

(22) Filed: Oct. 2, 2006

(51) Int. Cl. G06G 7/48; G06G 7/58

(52) U.S. Cl. 703/11

(57) ABSTRACT

The invention relates to a fast method for predicting one or more transmembrane (TM) regions of a membrane protein (MP). The invention also relates to a fast method for predicting 3D structure of MP.

### BACKGROUND OF THE INVENTION

1. Field of the invention

The invention relates to a fast method for predicting one or more transmembrane (TM) regions of a membrane protein (MP). The invention also relates to a fast method for predicting 3D structure of MP.

2. Description of the Related Art

Membrane proteins (MPs) play key roles in living cells, such as ion channels, drug receptors, and information transfers (Chapman, R., Sidrauski, C., and Walter, P. 1998, Annu. Rev. Cell Dev. Biol. 14:459-85; White, S. H. & Wimley, W. C. 1999, Annu. Rev. Biophys. Biomol. Struct. 28, 319; Bowie, J. U. 2005, Nature 438, 581-589). Functionally normal MPs are vital to survival and their defects lead to many known diseases. The clinical importance of MPs is demonstrated by the fact that more than 50% of known drugs are targeting on MPs (Heusser, C. & Jardieut. P 1997, Current Opinion in Immunology, 9:805-814; Moreau, J. L. & Huber, G. 1999, Brain Research Reviews 31: 65-82; Saragovi, H. U. & Gehring, K. 2000, TiPS. 21,93-98), which are also responsible for the uptake, metabolism, and clearance of these pharmacologically and toxicologically active substances. Only two structural motifs are observed for MPs: membrane-spanning α-helix bundles and β-barrels, the former being predominant. Although analyses show that more than a quarter of all proteins coded in genomes are MPs (Gerstein, M. 1998, Proteins 33, 518-534; Wallin, E. & von Heijne, G. 1998, Protein Sci. 7, 1029-1038; Krogh, A., Larsson, B., von Heijne, G., & Sonnhammer, E. L. 2001, J. Mol. Biol. 305, 567-580), due to difficulties in crystallizing MPs (Ostermeier, C. & Michel, H. 1997, Current Opinion in Structural Biology 7:697-701), only about 45 structures have been derived from X-ray crystallography or NMR (Prince, S. M., Achtman, M. and Derrick, J. P. 2002, Proc. Natl. Acad. Sci. USA 99, 3417-3421; Chimento et al., 2003, Nature Structural Biology 10:394-401). Therefore, there exist great incentives for computational and theoretical studies of MPs (Milik, M. & Skolnick, J. 1992, Proc. Natl. Acad. Sci. USA 89, 9391-9395; Chen, C.-M. 2000, Phys. Rev. E 63, 010901; Floriano, W. B., Vaidehi, N., Goddard III, W. A., Singer, M. S., & Shepherd, G. M. 2000, Proc. Natl. Acad. Sci. USA 97, 10712-10716). As the information technology advances, computer assisted structure predictions and dynamic studies of MPs might serve as a powerful tool to understand the biological functions of MPs.

The retinal proteins are MPs found in the purple membrane of Halobacterium salinarium, each with different functions: bacteriorhodopsin (BR) is a proton pump, halorhodopsin (HR) is a chloride pump, and sensory rhodopsins I and II (SRI and SRII) are photosensoric proteins. The two ion pumps, BR and HR, convert light energy for the bacteria to synthesize ATPs. The two photosensors, SRI and SRII, direct the bacteria toward optimal light conditions and to avoid exposure to photooxidative conditions. Retinal proteins are the focus of much interest and have become a paradigm for MPs in general and transporters in particular (Oesterhelt, D. 1976, Angew. Chem., Int. Ed. Engl. 15, 17-24). Their structure and function have been analyzed in great detail using a variety of experimental techniques. Structurally, they have a topology of seven transmembrane (TM) helices arranged in two arcs, an inner one containing helices B,. C, and D and an outer one comprising helices E, F, G. and A. Between helices B, C, F and G there is a TM pore, which accommodates a retinal to separate the extracellular half channel from the cytoplasmic half channel. Understanding the structure and folding dynamics of these membrane residing retinal proteins is crucial to further investigate their biological functions. The unique structural topology of retinal proteins serves as a simple model for the study of computer assisted structure predictions of MPs.

In previous studies (Chen, C.-M. & Chen, C.-C. 2003, Biophys. J. 84 1902), the bond-fluctuation model has been successfully used in a lattice space to demonstrate the folding of helix-bundle membrane proteins. However, due to lattice effects, the predicted folding structures of membrane proteins deviate drastically from the crystal structures of MPs. Basically, helices of predicted structures are all parallel to the membrane normal. Since the tilting and orientation of these helices are important for their biological functions, the previous predicted coarse-grained structures of MPs might not have any practical application. Refinement of these predicted structures at atomic resolution is also difficult.

### SUMMARY OF THE INVENTION

The invention relates to a fast method for predicting one or more transmembrane (TM) regions of a membrane protein (MP), comprising
(1) selecting peaks from average hydropathy index based on amino acid sequences of a window size between 5 to 40; and
(2) identifying exact sequences of TM regions possessing a low potential energy U by a residue-level coarse-grained simulation, wherein the low potential energy U is selected from the group consisting of from the lowest to the 10^{th} lowest potential energy U of the MP.

The invention also relates to a fast method for predicting 3D structure of MP, comprising
(1) predicting the location of TM helices in a membrane by using vdW interaction between helices E_{vdw}; and
(2) predicting the tilting of TM helices in a membrane by competing the helix-water interaction E_{hw} and helix-lipid interaction Eₕₗ.

The invention further relates to a fast method for predicting 3D structure of MP, comprising
(1) selecting peaks from average hydropathy index based on amino acid sequences of a window size between 5 to 40;
(2) identifying exact sequences of TM regions possessing a low potential energy U by a residue-level coarse-grained simulation, wherein the low potential energy U is selected from the group consisting of from the lowest to the 10^{th} lowest potential energy U of the MP;
(3) predicting the location of TM helices in a membrane by using vdW interaction between helices E_{vdw}; and
(4) predicting the tilting of TM helices in a membrane by competing the helix-water interaction E_{hw} and helix-lipid interaction Eₕₗ;
   and further comprises a refinement by all-atom molecular dynamics simulation.

### BRIEF DESCRIPTION OF THE DRAWINGS

FIG. 1 is a comparison of the predicted secondary structures of halorhodopsin to the crystal structure.

FIG. 2 shows the relationship between the average Θ_{rmsd} of 5 MPs (1AP9, 1E12, 1F88, 1H68, 1JGJ) and e₃/e₂.

FIG. 3 shows the tilting (Θ), orientational (Φ), and rotational (Ω) angles of a transmembrane helix.

FIG. 4 shows the energy of BR as a function of simulation time.

FIG. 5 is a comparison of the predicted structure of 3 MPs (bacteriorhodopsin, halorhodopsin, sensory rhodopsin II) to their individual X-ray structures. Only the intersection within the lipid midplane is shown here.

FIG. 6 shows the RMSD of backbone atoms of the seven helices of BR in the MD trajectory (curve 1), the potential energy curve of BR obtained from the restrained MD simulation starting from MC predicted structure (curve 2), and the potential energy curve of a restrained MD simulation starting from the x-ray structure (curve 3).

FIG. 7 is a comparison of BR structures from MC prediction (light gray) and MD refinement (dark gray) with its x-ray structure (black lines).

FIG. 8 is a comparison of SRII structures from MC prediction (light gray) and MD refinement (dark gray) with its x-ray structure (black lines).

FIG. 9 is a comparison of HR structures from MC prediction (light gray) and MD refinement (dark gray) with its x-ray structure (black lines).

FIG. 10 shows the RMSD of backbone atoms of the seven helices of SRII in the MD trajectory (curve 1), the potential energy curve of SRII obtained from the restrained MD simulation starting from MC predicted structure (curve 2), and the potential energy curve of a restrained MD simulation starting from the x-ray structure (curve 3).

FIG. 11 shows the RMSD of backbone atoms of the seven helices of HR in the MD trajectory (curve 1), the potential energy curve of BR obtained from the restrained MD simulation starting from MC predicted structure (curve 2), and the potential energy curve of a restrained MD simulation starting from the x-ray structure (curve 3).

FIG. 12 shows the total energy of BR as a function of temperature calculated by the multiple histogram method. The inset displays the specific heat Cᵥ, which indicates a two-state of helix packing of BR.

### DETAILED DESCRIPTION OF THE PREFERRED EMBODIMENT

In this invention, the model is improved in a continuous space, such that the lattice effects are removed. This new model also explains the physical origin of the packing, tilting, and orientation of the transmembrane helices. Furthermore, the new model of the invention is much faster and better in predicting the coarse-grained structures of MPs. The obtained structures of MPs in this invention are consistent with their known crystal structures. The root mean square deviation (RMSD) of our predicted structures from their known crystal structures are small enough for further refinement at atomic resolution. Our final predicted structures of retinal proteins have small RMSD, which can be used to study their biological functions and have important practical applications, such as drug design.

The invention provides a fast method for predicting one or more transmembrane (TM) regions of a membrane protein (MP), comprising
(1) selecting peaks from average hydropathy index based on amino acid sequences of a window size between 5 to 40; and
(2) identifying exact sequences of TM regions possessing a low potential energy U by a residue-level coarse-grained simulation, wherein the low potential energy U is selected from the group consisting of from the lowest to the 10^{th} lowest potential energy U of the MP.

The step (1) is performed based on Kyte-Doolittle scale. The window size is between 5 and 40. For a complete transmembrane segment, the window size is preferably between 12 and 30, more preferably between 17 and 27, and even more preferably between 22 and 25. For a half transmembrane segment, the window size is preferably between 5 and 15.

In the step (2), the low potential energy U is preferably selected from the group consisting of from the lowest to the 5^{th} lowest potential energy U of the MP. In a more preferred embodiment, the low potential energy U is selected from the group consisting of from the lowest to the 3^{rd} lowest potential energy U of the MP

During the step (2), the potential energy U of MP comprises potential energy of MP in membrane U_{membrane}, potential energy of MP in water U_{water} and spring potential energy of the bond between two residues U_{spring}.

The potential energy of MP in membrane U_{membrane} comprises hydrogen bonding energy in membrane E^{m}_{H-bond}, bending energy of the chain E_{bend} and the helix-lipid interaction Eₕₗ. First, the hydrogen bonding energy in membrane E^{m}_{H-bond} is determined according to the equation of

$${E}_{H - bond}^{m} = {e}_{m} \times {\sum }_{< i , j >} exp [ - {( r ( i , j ) - 6.0 )}^{2} ] \cdot {[ ( {n}_{i} \cdot {r}_{ij} ) ( {n}_{j} \cdot {r}_{ij} ) ]}^{4} ,$$

where eₘ is coefficient of the hydrogen bonding energy in membrane, nᵢ is the N—H (or O═C) bond orientation of the i-th amino acid, r(i, j) and rᵢⱼ are the distance and its unit vector between amino acids i and j. Second, the bending energy of the chain E_{bend} is determined according to the equation of E_{bend}=e_{b} Σᵢ (1−cosθᵢ), where e_{b} is the bending rigidity, θᵢ is the angle between two consecutive bonds i and i+1. Third, the helix-lipid interaction Eₕₗ is determined according to the equation of Eₕₗ=eₜ Σᵢ (1−cosΘᵢ), where Θᵢ is the tilting angle of the i-th helix and eₜ is the coefficient of the tilting energy.

The potential energy of MP in water U_{water} comprises hydrogen bonding energy in water E^{w}_{H-bond}, bending energy of the chain E_{bend} and the hydropathical interaction E_{hydropathy}. Among them, the hydrogen bonding energy in water E^{w}_{H-bond} is determined according to the equation of

$${E}_{H - bond}^{m} = {e}_{w} \times {\sum }_{< i , j >} {[ {( \frac{5.35}{r ( i , j )} )}^{12} - {( \frac{5.35}{r ( i , j )} )}^{6} ] [ ( {n}_{i} \cdot {r}_{ij} ) ( {n}_{j} \cdot {r}_{ij} ) ]}^{4} ,$$

where e_{w} is coefficient of the hydrogen bonding energy in water, nᵢ is the N—H (or O═C) bond orientation of the i-th amino acid, r(i, j) and rᵢⱼ are the distance and its unit vector between amino acids i and j. Second, the bending energy of the chain E_{bend} is determined according to the equation of E_{bend}=e_{b} Σᵢ(1−cosθᵢ), where e_{b} is the bending rigidity, θᵢ is the angle between two consecutive bonds i and i+1. Third, the hydropathical interaction E_{hydropathy} is modeled by a rescaled Kyte-Doolittle hydrophathy index with strength eₕ, which is mainly determined by the Gibbs free energy change for transferring amino acids from water into condensed vapor. In a preferred embodiment, the rescaled Kyte-Doolittle hydrophathy index is (Ala, Arg, Asn, Asp, Cys, Gln, Glu, Gly, His, Ile, Leu, Lys, Met, Phe, Pro, Ser, Thr, Trp, Tyr, Val)=(0.4, −1, −0.78, −0.78, 0.56, −0.78, −0.78, −0.09, −0.71, 1, 0.84, −0.87, 0.42, 0.62, −0.36, −0.18, −0.16, −0.2, −0.29, 0.93).

The spring potential energy of the bond between two residues (U_{spring}) is determined according to the equation of

$${U}_{spring} = {e}_{s} \times {\sum }_{i} {( {b}_{i} - {b}_{0} )}^{2} ,$$

where eₛ is spring constant, b₀ is the equilibrium bond length and bᵢ is the distance between amino acids.

In one embodiment, the TM region is a single helix or a fragment within a helix.

In one embodiment, length and location of the TM region are identified.

In one embodiment, the predicted TM regions of the MP are consistent with its crystal structure.

The invention also provides a fast method for predicting 3D structure of MP, comprising
(1) predicting the location of TM helices in a membrane by using vdW interaction between helices E_{vdw}; and
(2) predicting the tilting of TM helices in a membrane by competing the helix-water interaction E_{hw} and helix-lipid interaction Eₕₗ.

In a preferred embodiment, said method further comprises a refinement by all-atom molecular dynamics simulation. In a more preferred embodiment, the all-atom molecular dynamics simulation is performed with AMBER or CHARMM.

The said method for predicting 3D structure of MP is performed with a helix-level coarse-grained simulation calculating a lower total energy of E_{vdw}, E_{hw} and Eₕₗ.

In one embodiment, the vdW interaction between helices E_{vdw} is determined according to the equation of E_{vdw}=e₁Σ_{<ij>}Σ_{{m,n}}{[r₀/r(mᵢ,nⱼ)]¹²−[r₀/r(mᵢ,nⱼ)]⁶}, where e₁ is the strength of the vdW interaction, r(mᵢ,nⱼ) is the distance between m-th monomer in helix i and n-th monomer in helix j, and r₀ determines the minimum of E_{vdw}. In a preferred embodiment, the r₀ is selected from experimental data in the protein data bank (PDB) or measured by atomic force microscopy. This vdW interaction is a sum of all vdW energy between monomers, which is approximated without sequence dependence in our coarse-grained model. This sequence independent vdW interaction has successfully determined the relative helix positions for retinal proteins and aquaporins, provided that a suitable r₀ is given experimentally. For these ion channels, the inter-helix loops are short and helices are excluded from the pore region, which lead to a sequence non-specific packing of helices.

In one embodiment, the helix-water interaction E_{hw} is modeled by a rescaled Kyte-Doolittle hydrophathy index with strength e₂, which is mainly determined by the Gibbs free energy change for transferring amino acids from water into condensed vapor. In a preferred embodiment, the rescaled Kyte-Doolittle hydrophathy index is (Ala, Arg, Asn, Asp, Cys, Gln, Glu, Gly, His, Ile, Leu, Lys, Met, Phe, Pro, Ser, Thr, Trp, Tyr, Val)=(0.4, −1, −0.78, −0.78, 0.56, −0.78, −0.78, −0.09, −0.71, 1, 0.84, −0.87, 0.42, 0.62, −0.36, −0.18, −0.16, −0.2, −0.29, 0.93).

In one embodiment, the helix-lipid interaction Eₕₗ is determined according to the equation of Eₕₗ=e₃ Σᵢ(1−cosΘᵢ), wherein e₃ is the coefficient of the tilting energy, and Θᵢ is the tilting angle of the i-th helix.

In one embodiment, said method can further predict the orientation of TM helices in a membrane.

In one embodiment, a retinal molecule located the central of MP is concerned. In such cases, the method for predicting 3D structure of MP is performed with a helix-level coarse-grained simulation calculating a lower total energy of E_{vdw}, E_{hw}, Eₕₗ and E_{contact}, wherein the E_{contact} is a contact energy between the retinal molecule and helices of the MP. The contact energy between the retinal molecule and helices of the MP E_{contact} is determined according to the equation of

$${E}_{contact} = {e}_{4} {\sum }_{i = 1}^{7} ɛ ( Δ {r}_{i} ) ,$$

in which e₄ is the strength of the contact energy term, Δrᵢ is the shortest distance between the axes of retinal and i-th helix, and ε(Δrᵢ) is 1 if Δrᵢ is between 6 Å and 9 Å or 0 otherwise.

In one embodiment, the three-dimensional structure of MP is consistent with its crystal structure.

The present invention further provides a fast method for predicting 3D structure of MP, comprising
(1) selecting peaks from average hydropathy index based on amino acid sequences of a window size between 5 to 40;
(2) identifying exact sequences of TM regions possessing a low potential energy U by a residue-level coarse-grained simulation, wherein the low potential energy U is selected from the group consisting of from the lowest to the 10^{th} lowest potential energy U of the MP;
(3) predicting the location of TM helices in a membrane by using vdW interaction between helices E_{vdw}; and
(4) predicting the tilting of TM helices in a membrane by competing the helix-water interaction E_{hw} and helix-lipid interaction Eₕₗ.

In one embodiment, a retinal molecule located the central of MP is concerned. In such cases, the method for predicting 3D structure of MP is performed with a helix-level coarse-grained simulation calculating a lower total energy of E_{vdw}, E_{hw}, Eₕₗ and E_{contact} wherein the E_{contact} is a contact energy between the retinal molecule and helices of the MP. The contact energy between the retinal molecule and helices of the MP E_{contact} is determined according to the equation of

$${E}_{contact} = {e}_{4} {\sum }_{i = 1}^{7} ɛ ( Δ {r}_{i} ) ,$$

in which e₄ is the strength of the contact energy term, Δrᵢ is the shortest distance between the axes of retinal and i-th helix, and ε(Δrᵢ) is 1 if Δrᵢ is between 6 Å and 9 Å or 0 otherwise.

In a preferred embodiment, said method further comprises a refinement by all-atom molecular dynamics simulation. In a more preferred embodiment, the all-atom molecular dynamics simulation is performed with AMBER or CHARMM.

### EXAMPLES

The examples below are non-limiting and are merely representative of various aspects and features of the present invention.

### Example 1

### Secondary Structure Prediction

In this invention the potential energy U of MPs can be expressed as U=U_{membrane}+U_{water}+U_{spring}, where U_{membrane} and U_{water} are the potential energies of MPs in a membrane and in water respectively, and

$${U}_{spring} = {e}_{s} \times {\sum }_{i} {( {b}_{i} - {b}_{0} )}^{2}$$

the spring potential of the bond between two connected residues. The simulation box was divided into three regions including two water regions separated by a lipid bilayer of thickness L. For amino acids within the membrane, their potential energy was given by U_{membrane}=E^{m}_{H-bond}+E_{bend}+Eₕₗ, where E_{H-bond} was the hydrogen bonding energy, E_{bend} was the bending energy of the chain, and Eₕₗ was the helix-lipid interaction. A hydrogen bond can form if two amino acids were separated by 6 Å. However each amino acid can at most participate in two hydrogen bonds. Moreover hydrogen bonding was highly directional and has a maximal strength when N—H and O═C bonds were co-linear. Therefore the hydrogen bonding energy in membrane was modeled as

$${E}_{H - bond}^{m} = {e}_{m} \times {\sum }_{< i , j >} exp [ - {( r ( i , j ) - 6.0 )}^{2} ] \cdot {[ ( {n}_{i} \cdot {r}_{ij} ) ( {n}_{j} \cdot {r}_{ij} ) ]}^{4} ,$$

where nᵢ was the N—H (or O═C) bond orientation of the i-th amino acid, while r(ij) and rᵢⱼ were the distance and its unit vector between amino acids i and j. On the other hand, the hydrogen bonding in water was much weaker and we express it as

$${E}_{H - bond}^{w} = {e}_{w} \times {\sum }_{< i , j >} {[ {( \frac{5.35}{r ( i , j )} )}^{12} - {( \frac{5.35}{r ( i , j )} )}^{6} ] [ ( {n}_{i} \cdot {r}_{ij} ) ( {n}_{j} \cdot {r}_{ij} ) ]}^{4} .$$

Here eₘ and e_{w} were the coefficients of the hydrogen bonding energy in membrane and in water, respectively. Since the backbone hydrogen bonding in membrane was the dominant interaction for the formation of secondary structures of MPs, its energy strength was set to unity. Furthermore the possibility of forming 2₇ ribbons and 3₁₀ helices have been explicitly excluded here due to steric hindering by disallowing the hydrogen bonding between (i, i±2) and (i, i±3) pairs. The bending energy of the chain was assumed to be e_{b} Σᵢ(1−cosθᵢ), where e_{b} was the bending rigidity and θᵢ was the angle between two consecutive bonds i and i+1. The helix-lipid interaction is modeled by eₜ Σᵢ(1−cosΘᵢ), where Θᵢ is the tilting angle of the i-th helix relative to the membrane normal. For a larger value of Θᵢ, there is more contact between lipid molecules and the helix, which increases the perturbation of the membrane due to the presence of the helix. For amino acids in water, their interactions were modeled by a residue-residue contact potential (E_{contact}) and the hydropathical interaction (E_{hydropathy}), i.e., U_{water}=E^{w}_{H-bond}+E_{bend}+E_{hydropathy}. The interactions between the exposed residues and the lipid bilayer were ignored. The hydropathical interaction of amino acids in water can be modeled by using a rescaled Kyte-Doolittle hydrophathy index (Ala, Arg, Asn, Asp, Cys, Gln, Glu, Gly, His, Ile, Leu, Lys, Met, Phe, Pro, Ser, Thr, Trp, Tyr, Val)=(0.4, −1, −0.78, −0.78, 0.56, −0.78, −0.78, −0.09, −0.71, 1, 0.84, −0.87, 0.42, 0.62, −0.36, −0.18, −0.16, −0.2, −0.29, 0.93) with strength eₕ, which was mainly determined by the Gibbs free energy change for transferring amino acids from water into condensed vapor (Kyte and Doolittle, 1982). In the simulations of this invention, the parameter set (eₛ, eₜ, eₕ, e_{b}, eₘ, e_{w})=(10, 0.17, 0.66, 0.1, 1.0, 0.1) was used.

In the simulations of the present invention, the polymer chain was represented by a bead-spring model, and its motion was simulated by the Metropolis Monte-Carlo (MC) algorithm in a continuous space at a constant temperature T=0.2. Each bead represents a monomer of size a=1.8 Å and the bond length between two consecutive monomers was allowed to fluctuate around its equilibrium value b₀=3.8 Å with a spring constant eₛ=10. At each instant, a residue was picked up at random and attempts to move in any direction, and the move was accepted with probability p=min[1, exp(−ΔU/kT)], where ΔU was the energy change of the chain and kT was thermal energy.

### Example 2

### Comparison of the Predicted Secondary Structures of Halorhodopsin to the Crystal Structures Thereof

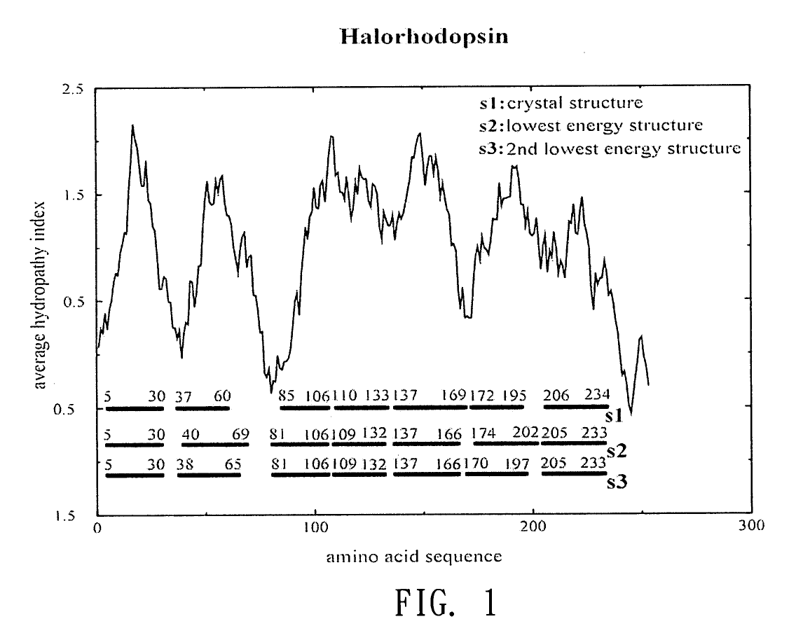

To begin with, the average hydropathy index of membrane proteins using a window of z=20-25 amino acids was calculated to find out the most probable transmembrane segments. The average hydropathy index of window size z=5-15 was also calculated to locate possible transmembrane segments that only extend half membrane thickness. In order to optimize the hydropathical interaction, the center of a transmembrane segment of z amino acids was located at those higher peaks of the hydropathy profile. Since no overlap was allowed for two segments, seven transmembrane segments were expected for the secondary structure of HR. It was also found that the window size has little effect on the peak positions of the average hydropathy. This observation was very useful in finding out the exact secondary structure of membrane proteins using computer simulations. To obtain the exact sequences of these transmembrane helices, MC simulations were then performed for each helix to find the lowest energy structure using the above model potential energy U. Here the membrane thickness L was set to be 33 Å. FIG. 1 shows the average hydropathy index for z=22 of HR and its transmembrane segments of the crystal structure, of the lowest energy structure (E=−130.6), and of the second lowest energy structure (E=−127.4). The average length of transmembrane helices was 26 amino acids for crystal structure, 27.7 amino acids for our lowest energy structure, and 27.3 amino acids for our second lowest energy structure. For the lowest energy structure, the prediction error in the average helix length was 6.5%, and the secondary structure alignment error (mismatch between it and the crystal structure) was 12.6%. For the second lowest energy structure, the prediction error in the average helix length was 5%, and the secondary structure alignment error (mismatch between it and the crystal structure) was 8.3%.

### Example 3

### Tertiary Structure Prediction

As proposed previously, it was assumed that the initial structure of retinal proteins contains seven random helices residing in the membrane, which were constrained by flexible inter-helix coils. These helices were allowed to diffuse in the membrane, and to tilt and rotate along the z-axis (the membrane normal direction). Among various physical interactions, evidences showed that the vdW interaction and side-chain packing among TM helices mostly determine the tertiary structure of MPs (White, S. H. & Wimley, W. C. 1999, Annu. Rev. Biophys. Biomol. Struct. 28, 319; Popot, J.-L. & Engelman, D. M. 1990, Biochemistry 29, 4031-4037; Popot, J.-L. & Engelman, D. M. 2000, Annu. Rev. Biochem. 69, 881-922). Although inter-helical hydrogen bonding, ion pairs, and disulfide bonds have been considered as alternative sources of stability, there were only few cases demonstrating the importance of these alternative interactions. In the model of the invention, the vdW interaction between helices was expressed as

E_{vdw}=e₁Σ_{{i,j}Σ}_{{m,n}}{[r₀/r(mᵢ,nⱼ)]¹²−[r₀/r(ₘᵢ,nⱼ)]⁶},

where e₁ was the strength of the vdW interaction and r₀ determines the minimum of E_{vdw}. The distance between m-th monomer in helice i and n-th monomer in helice j was denoted by r(mᵢ,nⱼ). Here each monomer represents a pitch (about 4 amino acids) in a helix. The helix-water interaction E_{hw} can be modeled by using the rescaled Kyte-Doolittle hydropathy index (spread between −1 and 1) with strength e₂, which was mainly determined by the Gibbs free energy change for transferring amino acids from water into condensed vapor (Kyte and Doolittle, 1982, J. Mol. Biol. 157, 105). For each coarse-grained monomer, its hydropathy index is a sum of its constituting amino acids. In addition, detailed studies of model hydrophobic helices in phospholipid bilayers have shown that lipids in the immediate neighborhood of a helix were perturbed due to the helix-lipid interaction (Subczynski et al., 1998, Biochemistry 37, 3156-3164). Thus, the helix-lipid interaction Eₕₗ was modeled by a tilting energy e₃ Σᵢ(1−cosΘᵢ) of the helices in the membrane, where Θᵢ was the tilting angle of the i-th helix. The tilting energy increased if a helix was tilted from the membrane normal, due to the increase in the contact between lipids and helix. Finally we discussed the effect of the retinal in stabilizing the channel state over a hexagonal packing state, which was expected to have a lower vdW energy. For such hexagonal packing state, the retinal was outside the helix bundle and had unfavorable contacts with lipids. Conversely, the retinal formed hydrogen bonding with water molecules and had favored contacts with helices, if it was in the channel state (Baudry, Crouzy, Roux, & J. C. Smith, 1999, Biophys. J. 76, 1909-1917). We thus modeled the noncovalent interaction between the retinal and its environment by a contact energy between retinal and helices,

$${E}_{contact} = {e}_{4} {\sum }_{i = 1}^{7} ɛ ( Δ {r}_{i} ) ,$$

where e₄ was the strength of the contact energy term, Δrᵢ was the shortest distance between the axes of retinal and i-th helix, and ε(Δrᵢ) was 1 if Are was between 6 Å and 9 Å or 0 otherwise. Therefore, to find the ground state structure of BR, the relevant physical quantity to be minimized in our model was the total energy E=E_{vdw}+E_{hw}+Eₕₗ+E_{contact}.

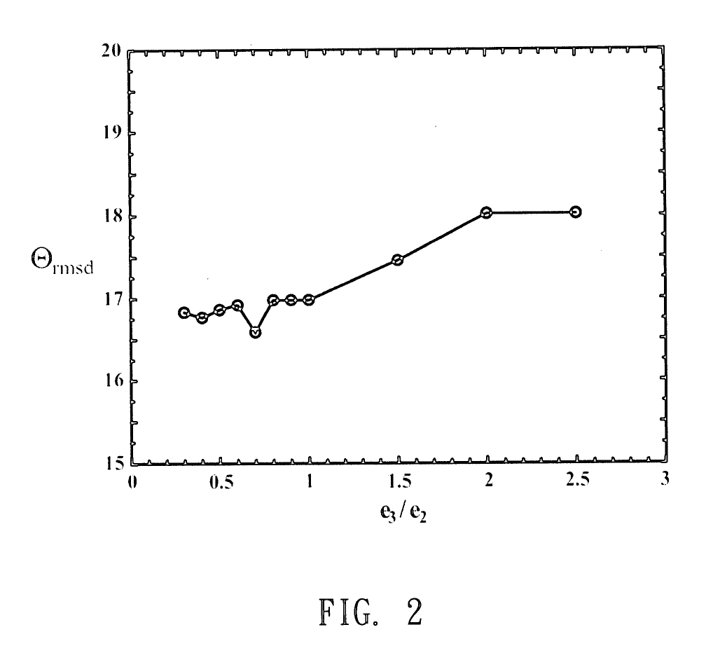

In this model, two parameters, r₀ and e₃/e₂, were crucial in determining the three-dimensional structure of MPs. The parameter r₀ in Eq. (1) determines the packing of helices and was set to 7.9 Å for BR, 8.2 Å for HR, and 8.5 Å for SRII from experimental data in the PDB. Alternatively, this parameter can also be measured by atomic force microscopy (Dufrêne, Y. F. 2004, Nature Rev. Microbiol. 2, 451-460) or by electron microscopy (Kunji, E. R. S., von Gronau, S., Oesterhelt, D., & Henderson, R. 2000, Proc. Natl. Acad. Sci. USA, 97, 4637-4642). By competing the helix-water and helix-lipid interactions, as shown in FIG. 2, the value of e₃/e₂ determines the tilting of helices, and was estimated to be about 0.7 by minimizing the root mean square deviation of the helix tilting angles,

$${Θ}_{rmsd} ≡ \sqrt{\frac{1}{n} \cdot {\sum }_{i = 1}^{n} {( {Θ}_{i} - {Θ}_{i}^{0} )}^{2}} .$$

Here Θᵢ and Θᵢ⁰ were the predicted and acquired tilting angles of helices, for the following five helix-bundle MPs in the PDB: 1AP9, 1E12, 1F88, 1H68, 1JGJ. To find the value of Θᵢ with the lowest energy, MC simulations of each helix have been carried out for various e₃/e₂ in our coarse-grained model. In other words, if one uses e₃/e₂=0.7 to predict the helix tilting of the above MPs, it is expected to obtain the best results. We note that the orientation angle Φ of helices cannot be accurately predicted in general using this coarse-grained model since the size of side chains was not included in this model. However, our predicted structure can be further refined by all-atom models in which the side chain effects can be properly studied.

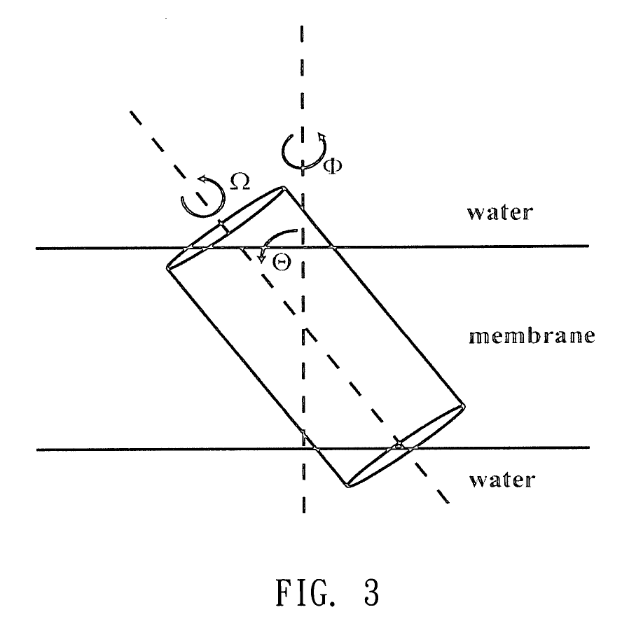

To analyze the structure and folding dynamics of MPs, the simulation box was divided into three regions: a membrane phase sandwiched by two water phases. No helix-water interaction was assumed in the membrane phase. The protein chain was represented by seven rigid cylinders (TM helices) located in the membrane phase and constrained by flexible inter-helical loops. The maximal lengths of these coarse-grained inter-helical loops were proportional to the number of residues in the loops. These TM helices can be identified on the basis of hydrophobicity as described in the first stage. The retinal was also represented by a rod of length 12 Å and radius 1.6 Å, which was covalently bound to the G-helix and fixed in the membrane (in perpendicular to the z-axis). The effect of this retinal molecule in the structure formation of retinal proteins was to block helices from entering the central position of the helix-bundle. The folding of retinal proteins was simulated by the Metropolis MC algorithm in a continuum space at a constant temperature T (Chen, C.-M. 2000, Phys. Rev. E 63, 010901). At each instant, a cylinder was picked up at random and attempts to diffuse, tilt (Θ), or rotate along the z-axis within the bilayer (Φ), as shown in FIG. 3. A rotation along the the long axis of a helix (Ω) is not considered in the present invention due to the simplification of a sequence independent vdW interaction. If any attempted move of cylinders satisfies the constraints of excluded volume and inter-helical loops, the move was accepted with probability w=min[1, exp(−ΔE/T)], where ΔE was the energy change of the system. In the simulations of the invention, it was set that e₁=0.25, e₂=1, e₃=0.7, e₄=−0.5, and kT=0.1.

### Example 4

### Comparison of the Predicted Tertiary Structure of Bacteriorhodopsin, Halorhodopsin, Sensory Rhodopsin to the Crystal Structures Thereof

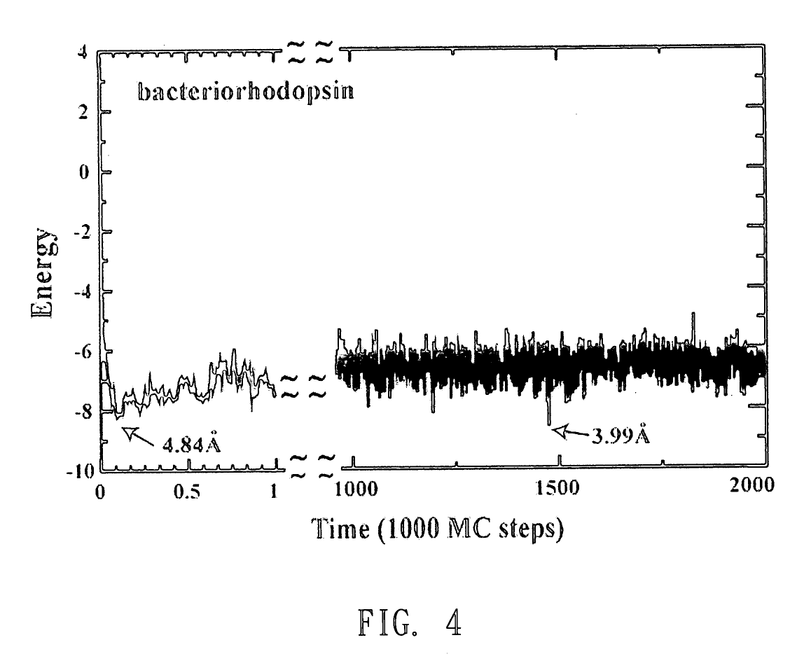

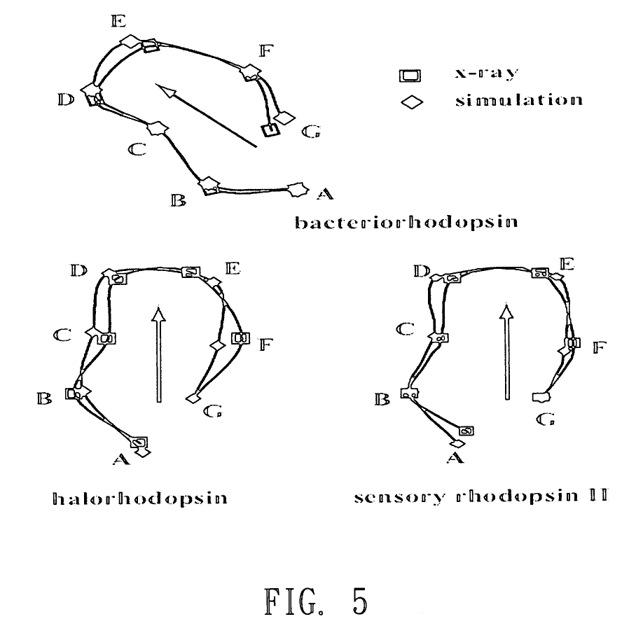

By this approach, the native structure of MPs can be efficiently predicted with a desktop computer. According to the thermodynamic hypothesis of protein folding, which is demonstrated by numerous denaturation-renaturation experiments, the native state of the protein is the global minimum of free energy. In this case, the native state is the lowest energy channel state of our coarse-grained protein model. For a typical run of BR folding, as shown in FIG. 4, the energy of BR drops rapidly from 4.0 to −8.3 during the first 100 MC steps (of RMSD 4.84 Å) and the lowest energy (−8.6) is observed at about 1.5 million MC steps (of RMSD 3.99 Å). In the inset of FIG. 4, the average helix positions of this ground state structure are compared to those of the crystal structure of BR, which shows a remarkable consistency. This ground state structure appears repeatedly in our MC simulations. A comparison of our prediction and the crystal structure of BR was shown in FIG. 5, which depicts the overlap of helix positions (midpoints of helices) of bacteriorhodopsin (BR), halorhodopsin (HR), and sensory rhodopsin II (SRII): open squares were for the crystal structure and close diamonds were for our predicted structure. The similarity between the x-ray structure and the predicted structure of these three retinal proteins confirms the conjecture in the two-stage model that the shape of membrane proteins was mainly determined by the vdW interaction in Eq. (1). In tables I-III, the predicted tilting (Θ) and orientation (Φ) angles of helices from our MC and MD simulations were compared to their values calculated from the crystal structure for BR, SRII, and HR. As expected, the predicted tilting angles were consistent with their values acquired from the crystal structure. The calculated value of Θ_{rmsd} from MC simulations was 8.28 degrees for bacteriorhodopsin, 4.84 degrees for halorhodopsin, and 5.66 degrees for sensory rhodopsin II. Slight improvement was found for the refined structure from MD simulations. The calculated value of Θ_{rmsd} was 5.87 degrees for bacteriorhodopsin, 4.82 degrees for halorhodopsin, and 3.29 degrees for sensory rhodopsin II. On the other hand, the predicted orientation angles could deviate from their experimental values substantially, due to the lack of information of the side-chain packing in our coarse-grained model. From our MC simulations, the calculated value of

$${Φ}_{rmsd} ≡ \sqrt{\frac{1}{7} \cdot {\sum }_{i = 1}^{7} {( {Φ}_{i} - {Φ}_{i}^{0} )}^{2}}$$

was 108.69 degrees for bacteriorhodopsin, 97.25 degrees for sensory rhodopsin II, and 18.90 degrees for halorhodopsin. The deviation in the predicted values of orientation angles can be greatly improved by including side-chain information into the coarse-grained model, or by refining the predicted structure in all-atom models. A refinement by a 5-10 ns constrained molecular dynamics (MD) simulation using Amber7 leads to a structure improvement of Φ_{rmsd}≅17.89 degrees for BR, 22.63 degrees for SRII, and 6.78 degrees for HR. Note that the tilting and rotational angles of retinal proteins in PDB are determined by aligning the shortest helix of retinal proteins along the z-axis, and the predicted angles are determined by minimizing Θ_{rmsd}.

TABLE I
Comparison of the MC predicted tilting (Θ) and orientation (Φ)
angles of each helices of bacteriorhodopsin to their values
calculated from the crystal structure.

| helix | Θ (PDB) | Θ (MC) | Θ (MD) | Φ (PDB) | Φ (MC) | Φ (MD) |
|---|---|---|---|---|---|---|
| A | 27.76 | 17.53 | 20.86 | 176.78 | 355.49 | 169.52 |
| B | 21.04 | 14.49 | 14.61 | 129.42 | 256.88 | 141.61 |
| C | 14.81 | 30.78 | 10.63 | 79.75 | 200.38 | 111.74 |
| D | 22.40 | 16.13 | 18.05 | 133.29 | 260.10 | 122.28 |
| E | 0.00 | 4.38 | 10.40 | arbitrary | 256.79 | 158.16 |
| F | 11.58 | 15.87 | 12.54 | 198.38 | 256.44 | 204.36 |
| G | 19.77 | 19.84 | 17.13 | 174.86 | 152.20 | 145.56 |

TABLE II
Comparison of the predicted tilting (Θ) and orientation (Φ)
angles of each helices of sensory rhodopsin II to their values
calculated from the crystal structure.

| helix | Θ (PDB) | Θ (MC) | Θ (MD) | Φ (PDB) | Φ (MC) | Φ (MD) |
|---|---|---|---|---|---|---|
| A | 26.94 | 15.36 | 26.70 | 202.64 | 233.18 | 215.67 |
| B | 9.94 | 11.11 | 3.44 | 175.13 | 14.19 | 228.32 |
| C | 0.00 | 8.00 | 1.64 | arbitrary | 133.00 | 150.18 |
| D | 15.81 | 16.55 | 18.76 | 190.31 | 6.38 | 192.58 |
| E | 20.25 | 22.55 | 23.91 | 256.06 | 279.72 | 234.30 |
| F | 20.79 | 22.73 | 18.56 | 231.27 | 286.88 | 224.54 |
| G | 22.54 | 18.67 | 24.48 | 227.99 | 271.49 | 220.04 |

TABLE III
Comparison of the predicted tilting (Θ) and orientation (Φ)
angles of each helices of halorhodopsin to their values
calculated from the crystal structure.

| helix | Θ (PDB) | Θ (MC) | Θ (MD) | Φ (PDB) | Φ (MC) | Φ (MD) |
|---|---|---|---|---|---|---|
| A | 22.98 | 29.09 | 28.15 | 201.21 | 198.05 | 206.86 |
| B | 9.07 | 9.88 | 13.44 | 152.73 | 138.71 | 146.59 |
| C | 0.00 | 6.57 | 5.94 | arbitrary | 83.53 | 167.86 |
| D | 15.50 | 13.15 | 7.43 | 175.68 | 134.13 | 167.20 |
| E | 18.36 | 18.56 | 16.03 | 247.98 | 270.78 | 248.29 |
| F | 14.96 | 22.21 | 18.05 | 223.97 | 217.13 | 236.75 |
| G | 19.29 | 24.27 | 20.27 | 211.01 | 212.44 | 215.12 |

### Example 5

### Tertiary Structure Refinement by All-Atom Molecular Dynamics Simulation

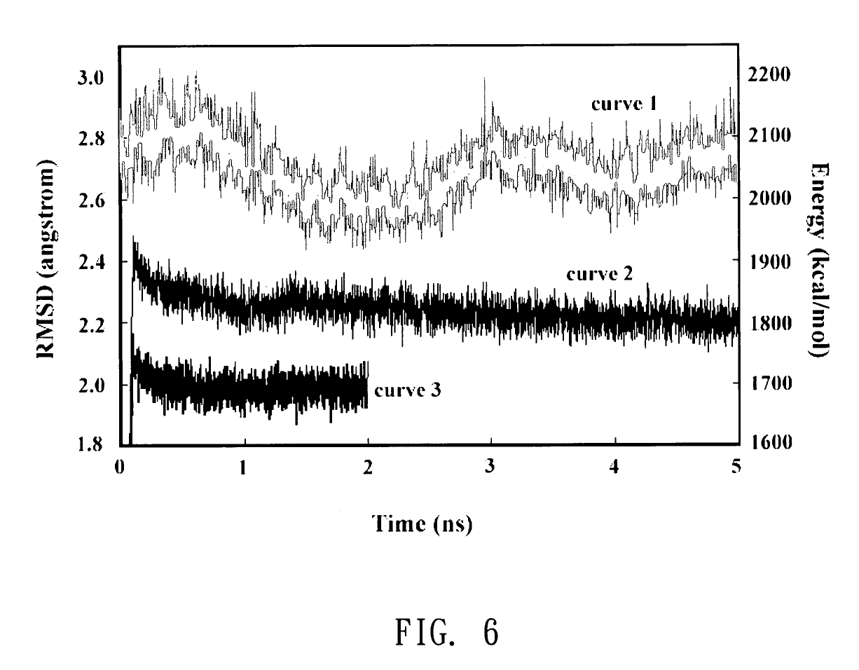

In addition to examination of folding dynamics and folded structure of MPs using a coarse-grained model, an all-atom calculation was desired to see if one can obtain MP folded structure at atomic level. To construct the all-atom representation of the predicted structure of BR from our coarse-grained MC simulations, the seven helices were built individually with the φ and ψ torsional angles of residues equal to −60 and −40 degree, respectively. Each helix was subject to an energy minimization using Amber7. The seven energy-minimized helices were then used to replace the rigid cylinders of BR in the coarse-grained model. After using the predicted cylindrical axes as the helical axes of BR, each helix can still have one degree of freedom to rotate along its axis. In principle, this rotational arrangement of helices can be achieved by another Monte-Carlo simulation by rotating the helical axes of BR. For simplicity, these seven helices were deliberately rotated such that the side chains located in the protein interior were consistent with those in the crystal structure. The overall RMSD in coordinates of backbone atoms from the x-ray structure for the coarse-grained model was 3.99 Å for all residues in the TM helices. In addition to the helix arrangement, the orientation of the retinal molecule was arranged according to the x-ray structure. The atomic charges of the retinal and Lys-216 was taken from Tajkhorshid's results (Tajkhorshid, E., Paizs, B., and Suhai, S. 1999, J. Phys. Chem. B, 103, 4518-4527). This structure was then refined by an energy minimization, which was proceeded with 5000 steps of steep descent method and 10000 steps of conjugate gradient method. The RMSD of this energy-minimized structure was 2.9 Å. Here the hydrophobic core of the membrane was treated as a dielectric medium of dielectric constant ε=2.5 (its value was between 2 and 4. Other values of ε (2.0 and 3.0) were also used, but no substantial differences in the folded structure were observed. Starting from the energy-minimized structure, we carry out restrained MD simulations to further refine the folded structure. These restraints include the φ and ψ angles and the distance between N and O atoms of hydrogen bonds in the helices. With these two restraint sets, as shown in FIG. 6, the 5 ns MD simulation gives a RMSD curve (curve 1) ranged 2.4-3.0 Å and the potential energy (curve 2) of BR decreases systematically with time from 1930 kcal/mol to below 1800 kcal/mol.

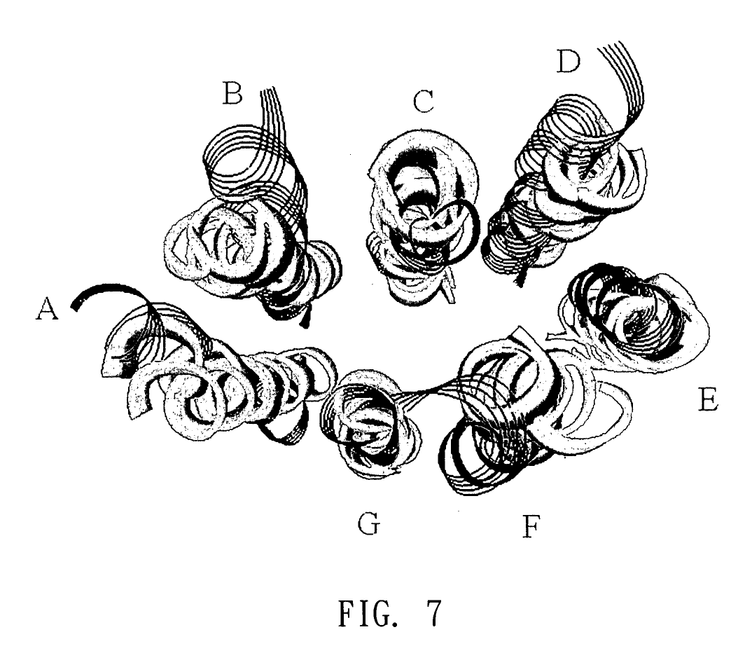

The three-dimensional structures of BR predicted from our simulations were compared to its x-ray structure as shown in FIG. 7, in which the seven helix structures of BR were depicted for the x-ray structure (black lines), MC prediction (light gray), and MD refinement (dark gray). The similarity among these three structures validates our model. It was apparent, from FIG. 7, that the prediction of most helices in BR was further improved by the atomic model. The overall RMSD in coordinates of backbone atoms from the x-ray structure for the coarse-grained model was 3.99 Å for all residues in the TM helices. Refinement of our predicted structure using Amber reduces the RMSD to 2.64 Å. In table I, the predicted tilting Θ and orientation Φ angles of helices were compared to their values calculated from the x-ray structure. As expected, the predicted tilting angles were consistent with their values acquired from the x-ray structure. The calculated value of Θ_{rmsd} was 8.28 degrees. On the other hand, the predicted orientation angles deviate from their experimental values substantially, due to the lack of information of the side-chain packing in our coarse-grained model. The calculated value of Φ_{rmsd} was 108.69 degrees. The deviation in the predicted values of orientation angles can be greatly improved by including side-chain information into the coarse-grained model, or by refining the predicted structure in all-atom models. A refinement by a 5 ns restrained MD simulation leads to a structure of Φ about 18 degrees.

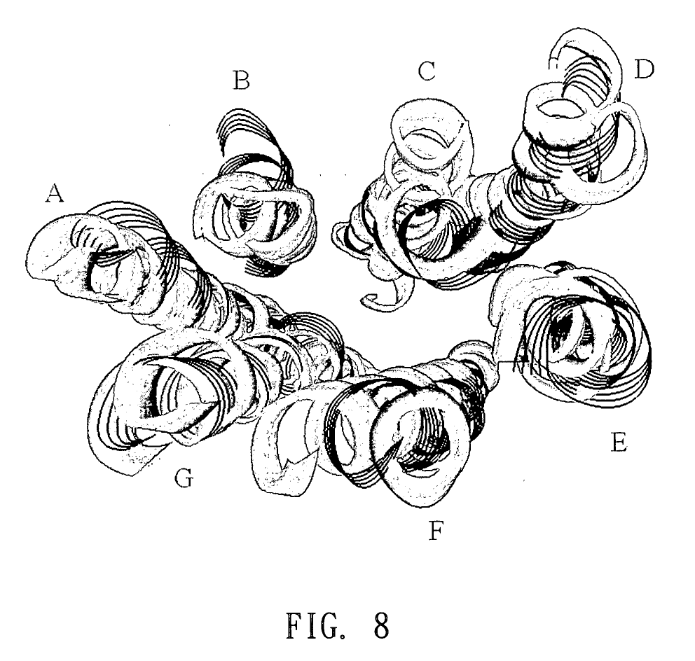

FIG. 8 shows an overlap of the x-ray structure of sensory rhodopsin II (SRII) with the predicted and refined structures in our computer simulations. For SRII, the RMSD of our coarse-grained model-predicted structure from its crystal structure was 3.12 Å, and the RMSD of the refined structure from its crystal structure was reduced to 1.92 Å.

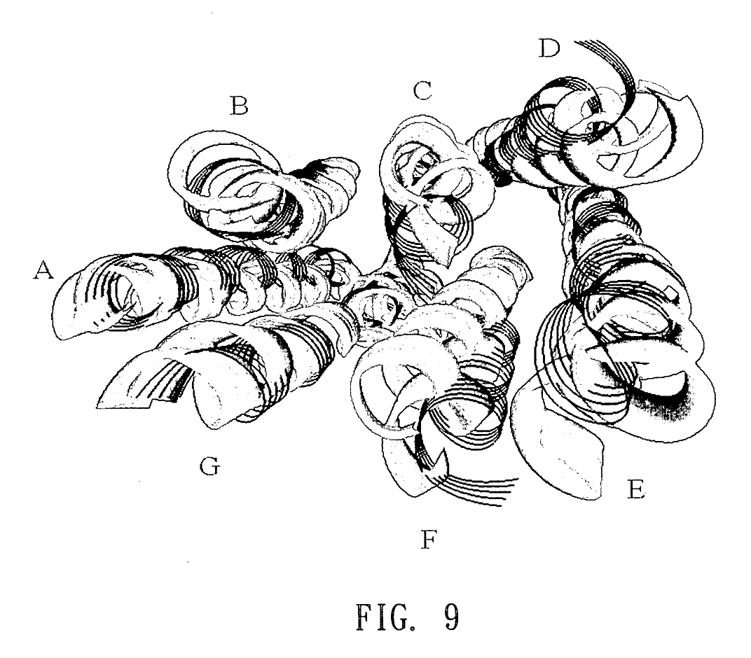

FIG. 9 shows an overlap of the x-ray structure of halorhodopsin (HR) with the predicted and refined structures in our computer simulations. For HR, the RMSD of our coarse-grained model-predicted structure from its crystal structure was 2.59 Å, and the RMSD of the refined structure from its crystal structure was reduced to 1.89 Å.

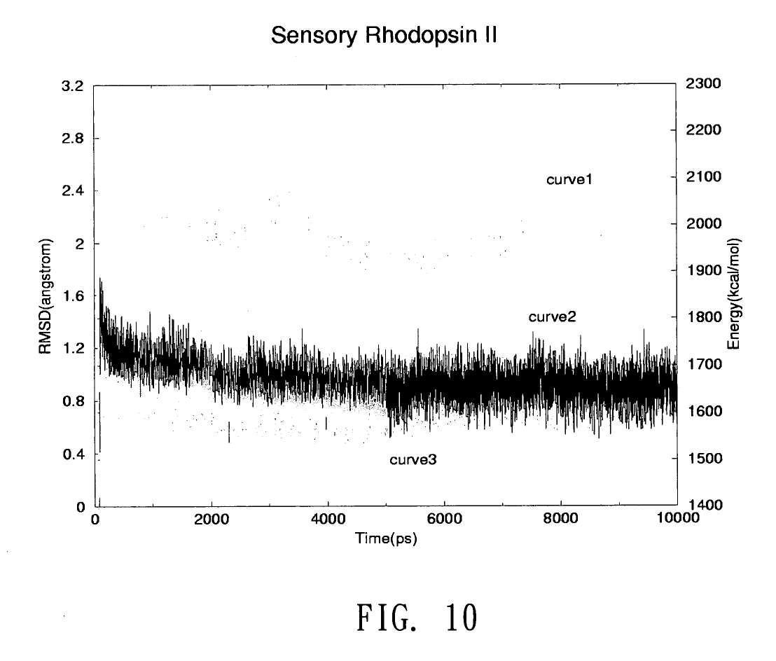

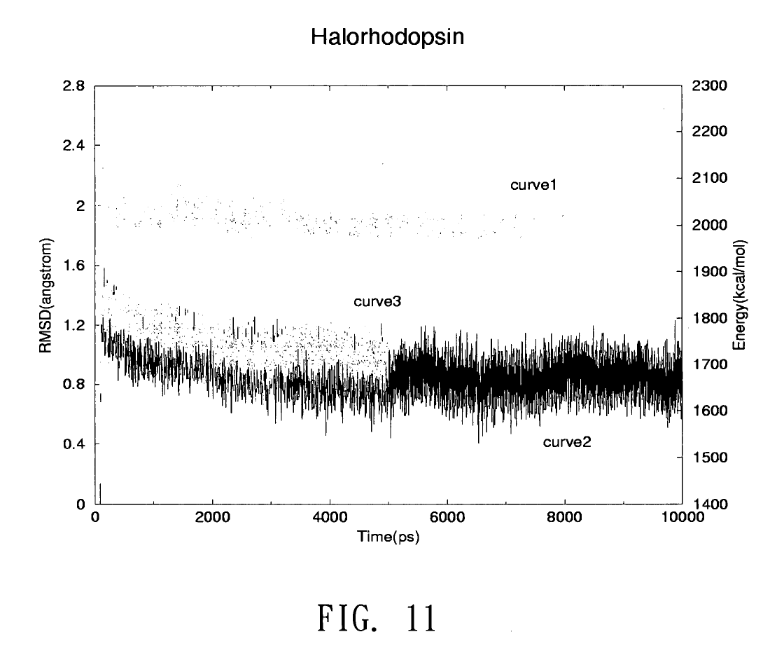

FIGS. 10 and 11 show the RMSD (curve 1) and potential energy (curve 2) as a function simulation time for SRII and HR. The curve 3 was the potential energy of the crystal structure of SRII and HR as a function of simulation time. It was clearly seen that the potential energy of the predicted structures was almost identical with that of the crystal structure of SRII and HR. This demonstrates the capability of the algorithm of the invention to predict the structure of membrane proteins.

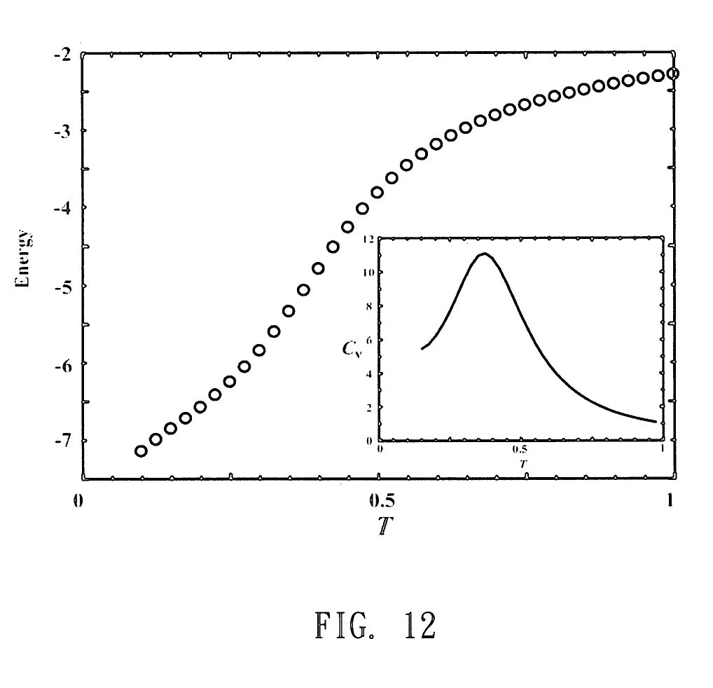

After successfully predicting the native structure of various retinal proteins with minimal experimental information, it was believed that those interactions in this model of the present invention should dominate the folding process of MPs and that this model was suitable for studying their folding dynamics. Here the multiple histogram method was used to calculate various thermodynamic quantities (Ferrenberg, A. M. and Swendsen, R. H. 1989, Phys. Rev. Lett. 63, 1195-1198). As shown in FIG. 12, the total energy of BR as a function of temperature was calculated from our MC simulations at five different temperatures. The specific heat of BR as a function of temperature was shown in the inset of FIG. 12. A pronounced single peak at T=0.4 observed in the specific heat curve.

One skilled in the art readily appreciates that the present invention is well adapted to carry out the objects and obtain the ends and advantages mentioned, as well as those inherent therein. The predicted secondary and tertiary structures of BR, SRII and HR are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

What is claimed is:

1. A fast method for predicting one or more transmembrane (TM) regions of a membrane protein (MP), comprising
(1) selecting peaks from average hydropathy index based on amino acid sequences of a window size between 5 to 40; and
(2) identifying exact sequences of TM regions possessing a low potential energy U by a residue-level coarse-grained simulation, wherein the low potential energy U is selected from the group consisting of from the lowest to the 10^{th} lowest potential energy U of the MP.

2. The fast method of claim 1, wherein the window size is between 12 and 30.

3. The fast method of claim 1, wherein the step (1) is performed based on Kyte-Doolittle scale.

4. The fast method of claim 1, wherein the low potential energy U is selected from the group consisting of from the lowest to the 5^{th} lowest potential energy U of the MP.

5. The fast method of claim 4, wherein the low potential energy U is selected from the group consisting of from the lowest to the 3^{rd} lowest potential energy U of the MP.

6. The fast method of claim 1, wherein the potential energy U of MP comprises potential energy of MP in membrane U_{membrane}, potential energy of MP in water U_{water} and spring potential energy of the bond between two residues U_{spring}.

7. The fast method of claim 6, wherein the potential energy of MP in membrane U_{membrane} comprises hydrogen bonding energy in membrane E^{m}_{H-bond}, bending energy of the chain E_{bend} and the helix-lipid interaction Eₕₗ.

8. The fast method of claim 7, wherein the hydrogen bonding energy in membrane E^{m}_{H-bond} is determined according to the equation of
$${E}_{H - bond}^{m} = {e}_{m} \times {\sum }_{< i , j >} exp [ - {( r ( i , j ) - 6.0 )}^{2} ] \cdot {[ ( {n}_{i} \cdot {r}_{ij} ) ( {n}_{j} \cdot {r}_{ij} ) ]}^{4} ,$$
in which eₘ is the coefficient of the hydrogen bonding energy in membrane, nᵢ is the N—H (or O═C) bond orientation of the i-th amino acid, r(ij) and rᵢⱼ are the distance and its unit vector between amino acids i and j.

9. The fast method of claim 7, wherein the bending energy of the chain E_{bend} is determined according to the equation of
E_{bend}=e_{b} Σᵢ(1−cosθᵢ),
in which e_{b} is the bending rigidity, θᵢ is the angle between two consecutive bonds i and i+1.

10. The fast method of claim 7, wherein the helix-lipid interaction Eₕₗ is determined according to the equation of
Eₕₗ=eₜ Σᵢ(1−cosΘᵢ),
in which eₜ is the tilting parameter, and Θᵢ is the tilting angle of the i-th helix.

11. The fast method of claim 6, wherein the potential energy of MP in water U_{water} comprises hydrogen bonding energy in water E^{w}_{H-bond}, bending energy of the chain E_{bend} and the hydropathical interaction E_{hydropathy}.

12. The fast method of claim 11, wherein the hydrogen bonding energy in water E^{w}_{H-bond} is determined according to the equation of
$${E}_{H - bond}^{w} = {e}_{w} \times {\sum }_{< i , j >} {[ {( \frac{5.35}{r ( i , j )} )}^{12} - {( \frac{5.35}{r ( i , j )} )}^{6} ] [ ( {n}_{i} \cdot {r}_{ij} ) ( {n}_{j} \cdot {r}_{ij} ) ]}^{4}$$
in which e_{w} is coefficient of the hydrogen bonding energy in water, nᵢ is the N—H (or O═C) bond orientation of the i-th amino acid, r(ij) and rᵢⱼ are the distance and its unit vector between amino acids i and j.

13. The fast method of claim 11, wherein the bending energy of the chain E_{bend} is determined according to the equation of
E_{bend}=e_{b} Σᵢ(1−cosθᵢ),
in which e_{b} is the bending rigidity, θᵢ is the angle between two consecutive bonds i and i+1.

14. The fast method of claim 11, wherein the hydropathical interaction E_{hydropathy} is modeled by a rescaled Kyte-Doolittle hydrophathy index with strength eₕ, which is mainly determined by the Gibbs free energy change for transferring amino acids from water into condensed vapor.

15. The fast method of claim 14, wherein the rescaled Kyte-Doolittle hydrophathy index is (Ala, Arg, Asn, Asp, Cys, Gln, Glu, Gly, His, Ile, Leu, Lys, Met, Phe, Pro, Ser, Thr, Trp, Tyr, Val)=(0.4, −1, −0.78, −0.78, 0.56, −0.78, −0.78, −0.09, −0.71, 1, 0.84, −0.87, 0.42, 0.62, −0.36, −0.18, −0.16, −0.2, −0.29, 0.93).

16. The fast method of claim 6, wherein the spring potential energy of the bond between two residues U_{spring} is determined according to the equation of
$${U}_{spring} = {e}_{s} \times {\sum }_{i} {( {b}_{i} - {b}_{0} )}^{2} ,$$
in which eₛ is the spring constant, b₀ is the equilibrium bond length and bᵢ is the distance between amino acids.

17. The fast method of claim 1, wherein the TM region is a single helix or a fragment within a helix.

18. The fast method of claim 1, wherein length and location of the TM region are identified.

19. The fast method of claim 1, wherein the predicted TM regions of the MP are consistent with its crystal structure.

20. A fast method for predicting 3D structure of MP, comprising
(1) predicting the location of TM helices in a membrane by using the vdW interaction between helices, E_{vdw}; and
(2) predicting the tilting of TM helices in a membrane by competing the helix-water interaction E_{hw} and helix-lipid interaction Eₕₗ.

21. The fast method of claim 20, which is performed with a helix-level coarse-grained simulation calculating a lower total energy of E_{vdw}, E_{hw} and Eₕₗ.

22. The fast method of claim 21, wherein the vdW interaction between helices E_{vdw} is determined according to the equation of
E_{vdw}=e₁Σ_{<ij>}Σ_{{m,n}}{[r₀/r(mᵢ,nⱼ)]¹²−[r₀/r(mᵢ,nⱼ)]⁶},
in which e₁ is the strength of the vdW interaction, r(mᵢ,nⱼ) is the distance between m-th monomer in helice i and n-th monomer in helice j, and r₀ determines the minimum of E_{vdw}.

23. The fast method of claim 22, wherein the r₀ is selected from experimental data in the PDB or measured by atomic force microscopy.

24. The fast method of claim 21, wherein the helix-water interaction E_{hw} is modeled by a rescaled Kyte-Doolittle hydrophathy index with strength e₂, which is mainly determined by the Gibbs free energy change for transferring amino acids from water into condensed vapor.

25. The fast method of claim 24, wherein the rescaled Kyte-Doolittle hydrophathy index is (Ala, Arg, Asn, Asp, Cys, Gln, Glu, Gly, His, Ile, Leu, Lys, Met, Phe, Pro, Ser, Thr, Trp, Tyr, Val)=(0.4, −1, −0.78, −0.78, 0.56, −0.78, −0.78, −0.09, −0.71, 1, 0.84, −0.87, 0.42, 0.62, −0.36, −0.18, −0.16, −0.2, −0.29, 0.93).

26. The fast method of claim 21, wherein the helix-lipid interaction Eₕₗ is determined according to the equation of
Eₕₗ=e₃ Σᵢ(1−cosΘᵢ),
in which e₃ is the tilting parameter and Θᵢ is the tilting angle of the i-th helix.

27. The fast method of claim 20, which can further predict the orientation of TM helices in a membrane.

28. The fast method of claim 20, wherein a retinal molecule located the central of MP is concerned.

29. The fast method of claim 28, which is performed with a helix-level coarse-grained simulation calculating a lower total energy of E_{vdw}, E_{hw}, Eₕₗ and E_{contact}, wherein the E_{contact} is a contact energy between the retinal molecule and helices of the MP.

30. The fast method of claim 29, wherein the contact energy between the retinal molecule and helices of the MP E_{contact} is determined according to the equation of
$${E}_{contact} = {e}_{4} {\sum }_{i = 1}^{7} ɛ ( Δ {r}_{i} ) ,$$
in which e₄ is the the strength of the contact energy, Δrᵢ is the shortest distance between the axes of retinal and i-th helix, and ε(Δrᵢ) is 1 if Δrᵢ is between 6 Å and 9 Å or 0 otherwise.

31. The fast method of claim 20, wherein the three-dimensional structure of MP is consistent with its crystal structure.

32. The fast method of claim 20, further comprising a refinement by all-atom molecular dynamics simulation.

33. The fast method of claim 32, wherein the all-atom molecular dynamics simulation is performed with AMBER or CHARMM.

34. A fast method for predicting 3D structure of MP, comprising
(1) selecting peaks from average hydropathy index based on amino acid sequences of a window size between 5 to 40;
(2) identifying exact sequences of TM regions possessing a low potential energy U by a residue-level coarse-grained simulation, wherein the low potential energy U is selected from the group consisting of from the lowest to the 10^{th} lowest potential energy U of the MP;
(3) predicting the location of TM helices in a membrane by using the vdW interaction between helices, E_{vdw}; and
(4) predicting the tilting of TM helices in a membrane by competing the helix-water interaction E_{hw} and helix-lipid interaction Eₕₗ.

35. The fast method of claim 34, wherein a retinal molecule located the central of MP is concerned during the steps (3) and (4).

36. The fast method of claim 35, which is performed with a helix-level coarse-grained simulation calculating a lower total energy of E_{vdw}, E_{hw}, Eₕₗ and E_{contact}, wherein the E_{contact} is a contact energy between the retinal molecule and helices of the MP.

37. The fast method of claim 36, wherein the contact energy between the retinal molecule and helices of the MP E_{contact} is determined according to the equation of
$${E}_{contact} = {e}_{4} {\sum }_{i = 1}^{7} ɛ ( Δ {r}_{i} ) ,$$
in which e₄ is the the strength of the contact energy, Δrᵢ is the shortest distance between the axes of retinal and i-th helix, and ε(Δrᵢ) is 1 if Δrᵢ is between 6 Å and 9 Å or 0 otherwise.

38. The fast method of claim 34, further comprising a refinement by all-atom molecular dynamics simulation.

39. The fast method of claim 38, wherein the all-atom molecular dynamics simulation is performed with AMBER or CHARMM.
